(19) United States
(12) Patent Application Publication
(10) Pub. No.: US 2025/0067168 A1
(43) Pub. Date: Feb. 27, 2025

(54) CASING COLLAR LOCATOR DETECTION AND DEPTH CONTROL

(71) Applicant: Schlumberger Technology Corporation, Sugar Land, TX (US)

(72) Inventors: Suraj Kiran Raman, Cambridge, MA (US); Muhannad Abuhaikal, Cambridge, MA (US); Arnaud Croux, Cambridge, MA (US)

(21) Appl. No.: 18/724,959

(22) PCT Filed: Mar. 16, 2023
(86) PCT No.: PCT/US2023/015340

§ 371 Date: Jun. 27, 2024

Related U.S. Application Data
(60) Provisional application No. 63/269,442, filed on Mar. 16, 2022.

(51) Int. Cl. E21B 47/09; E21B 23/14; G01B 21/18

(52) U.S. Cl. CPC E21B 47/09; E21B 23/14; G01B 21/18; E21B 2200/20; E21B 2200/22

(57) ABSTRACT

Systems and methods for estimating tool string depth can include a framework that utilizes machine learning to determine depth and depth uncertainties for the tool string. The framework can take as inputs a casing collar locator signal, a depth, a cable speed, and a timestamp. Then a collar detector function, which can be a machine learning model, can detect a collar and output a certainty level associated with the detection. A collar identifier function can combine that certainty level with a prior collar map and other prior parameters to identify a particular collar and that collar's depth. Then a fusion function can output a depth and depth uncertainty for the collar or for the tool string.

### CROSS-REFERENCE TO RELATED APPLICATIONS

This application claims priority to provisional application No. 63/269,442, titled “Casing Collar Locator Detection and Depth Control,” filed on Mar. 16, 2022, the contents of which are incorporated by reference.

### BACKGROUND

Accurate real-time tool-string depth estimation is key to acquiring high-quality wireline (“WL”) logs. WL logs are created based on finishing an interval, a section, or a well. Data acquired from tools like casing collar locators (“CCLs”), gamma rays, and accelerometers provide additional information that help correct and improve tool-string depth estimation. Currently clients use this kind of data to manually match prior information and update the tool-string depth estimate.

In wireline systems employed in the oil and gas industry to perform operations in wellbores, movement and placement of tool strings may be facilitated by use of winches above ground, and tractors attached to the tool strings. WL logs allow an operator to know how to control a tool string through a well bore. Depth of the tool-string, as measured from the surface using an integrated depth measuring wheel device (“IDW”), potentially leads to inaccuracies over time due to the uncertainties involved because of thermal and elastic deformations. During tractor operation of the tool string, an operator may need to operate a drive winch, spool cable, adjust tractor arm force, and adjust tractor speed. All the while, the operator must monitor readings from pieces of equipment that sense and measure a multitude of operating parameters.

However, current systems do not allow for easy depth correlation and matching of data to update the tool-sting depth estimate. Many systems do not accurately quantify real-time tool string depth estimates relative to associated uncertainty. Instead, the operator is often left to more trial-and-error than optimal when driving the tool string.

Therefore, a need exists for improved systems and methods for casing collar detection with CCL logs, thereby enabling accurate depth control.

### SUMMARY

Examples described herein include systems and methods for casing collar detection, matching, and depth control, particularly through use of machine learning. For example, the system can include a framework that automates CCL-based depth correlation and matching, providing real-time tool string depth estimates accurately and quantified with the associated uncertainty.

One or more processor-based computing devices can utilize CLL signal measurements and prior information to make depth measurements and determine depth uncertainty. A collar detector can be a process that includes a machine learning model in one example. The collar detector can on a processor and receive a casing collar locator signal, a depth stamp, and a prior parameter (also called “priors” or “prior information”). These priors can include casing tallies, reference CCL logs, and known features of the wellbore or collar. When a collar is detected, the collar detector can output a detection depth and a collar detection probability.

These outputs can be received at a collar identifier, which can be an additional process that provides correlation functionality. The collar identifier can execute on the same or different processor(s) to the collar detector. In addition to the outputs of the collar detector, prior parameters can also be inputs to the collar identifier. The collar identifier can output a collar depth and a collar identifier.

A fusion process can correlate prior information when the detection probability meets a threshold. The framework can then output a depth and depth certainty for the collar.

The system can include a machine learning (“ML”) model or algorithm that considers inputs from multiple real-time tool measurements to estimate and correct tool-string depth. This fusion of sensor inputs can allow for accurate depth estimation with uncertainty quantification in real-time. In one example, the estimation can be used for determining physical along-hole absolute depth.

The system can provide an automated detection and matching framework that is flexible across different use cases and operates in real time. This technology can be applicable to any device that can be lowered into a well with a feature detection tool. Therefore, although examples are discussed for use with wireline, the examples can apply to other devices, such as coiled tubing, drilling, etc.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

The CCL detection and matching can produce other benefits as well. For example, the methods can estimate physical along-hole absolute depth in real-time. Bayesian sensor fusion can output depth estimation, correction, and uncertainty quantification in real-time. Machine Learning can be used for detection methods by localizing casing collar signatures from CCL signals acquired using magnetic or acoustic casing collar locator tools. In one example, the framework can match against different user priors such as casing tallies, reference CCL logs, and known features.

The system can provide for collar detection and matching in almost real-time. The system can continuously estimate physical-along-hole depth. The system can also provide a detection and matching framework that can be adapted across different priors. The system can be applicable to any device that can be lowered into a well with a feature detection tool. This includes wireline, coiled tubing, drilling, etc.

The collar detector and feature identifier can execute on one or more computing devices using one or more processors. The results can be fused together by one or more processors to output depth and depth uncertainty measurements. A non-transitory, computer-readable medium can contain instructions that are executed by the one or more processors to implement the machine learning model of the collar detector and the machine learning model or correlation technique of the feature identifier.

Both the foregoing general description and the following detailed description are exemplary and explanatory only and are not restrictive of the examples, as claimed.

### BRIEF DESCRIPTION OF THE DRAWINGS

FIG. 1 is an illustration of an exemplary sensor fusion framework system suitable for use in oil and gas operations, according to an aspect of the present disclosure.

FIG. 2 is a schematic of an exemplary collar detector block according to an aspect of the present disclosure.

FIG. 3 is an illustration of an exemplary collar detector block according to an aspect of the present disclosure.

FIG. 4 is a schematic of an exemplary feature identifier model according to an aspect of the present disclosure.

FIG. 5 is a schematic of an exemplary feature identifier model according to an aspect of the present disclosure.

FIG. 6 is a schematic of an exemplary depth estimator framework according to an aspect of the present disclosure.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Continuous tool-string depth estimation is crucial to acquiring high-quality WL logs. WL logs enable clients to perform depth-specific jobs accurately. Depth of the tool-string, as measured from the surface using an IDW, potentially leads to inaccuracies over time due to the uncertainties involved because of thermal and elastic deformations. The presence of real-time measurements from various tools such as casing color locators, gamma rays and accelerometers in addition to the depth and cable speed measured on surface, provides an opportunity for intelligent sensor fusion frameworks that could help improve and correct tool-string depth continually.

The system can include a framework that employs advanced ML techniques coupled with Bayesian Sensor Fusion techniques to effectively fuse different tool measurements to estimate, correlate and correct tool-string depth. The framework can be used with measurements from a Casing Collar Locator sensor. Other applications are also possible.

In one example, a user may be interested in continual depth estimation for performing a depth-specific job. The user can provide one or more prior known information that are further used to detect, match and fuse real-time measurements. For example, the user can utilize a graphical user interface (“GUI”) on a user device to enter the prior information (“priors”).

The prior information can include approximate depth of a known feature along with a feature descriptor. The prior information can also be reference CCL logs from prior jobs on the same well. In one example, the user can provide casing tallies containing information on casing joint lengths and their approximate setting depths.

Each of the above priors can carry an uncertainty in measurement either due to the sensor (such as the case with Reference Logs) or due the random and systematic errors while making manual measurements (which is the situation with Casing Tallies and other Known Features). To address all the above use-cases, the framework can be broken into three functional components: the Collar Detector, Feature Identifier, and Depth Estimator. These functional components can operate on a server or the user device and can work together to provide depth outputs that allow for real time adjustment of the tool-string or adjustment to the WL logs.

The system can run on one or more processor-enabled devices.

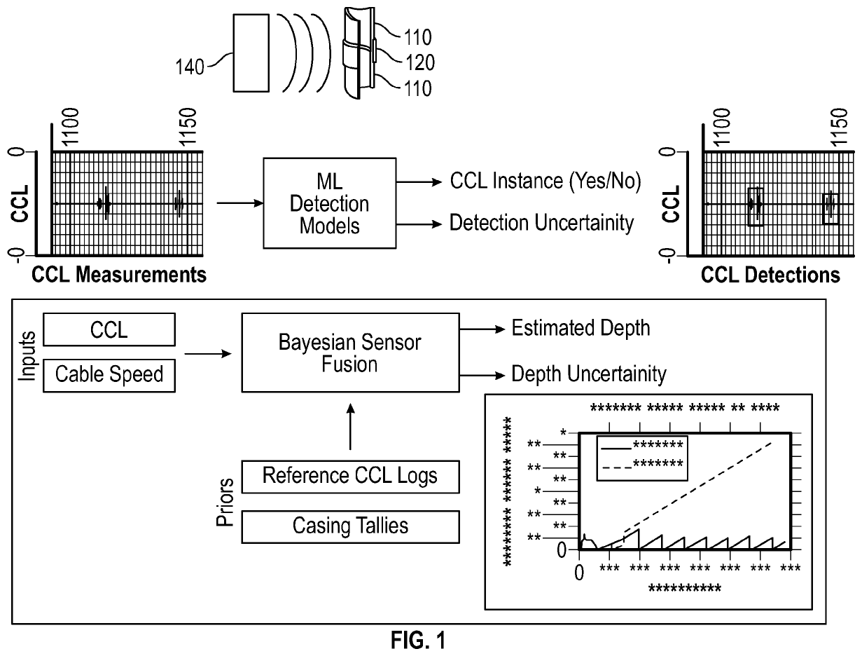

FIG. 1 is an illustration of an exemplary sensor fusion framework system suitable for use in oil and gas operations, according to as aspect of the present disclosure. The figure relates to a casing string in a well. The casing string can include multiple casing joints 110 with casing collars 120 between the casing joints 110. Casing collar locator, referred to as CCLs, can be magnetic or ultrasonic tools used to detect casing anomalies through a change in material thickness. For example, the CCL tool 140 can detect flux change.

CCLs are designed to detect the presence of casing collars 120, which are small ridges or indentations on the inside of wellbore casings. Casing collars 120 are used to provide mechanical support to the casing and prevent it from collapsing under the weight of the surrounding rock formations.

CCLs work by emitting electromagnetic signals that are reflected back by the casing collars. The tool measures the time it takes for the signals to travel back and forth and uses this information to determine the location of the casing collars. This data is then used to create a detailed log of the wellbore, which can be used to identify the depth and thickness of various formations, as well as the location of any obstructions or anomalies in the well. By accurately locating casing collars, operators can ensure that wellbore completions are properly positioned and that the casing is adequately supported, which can help to prevent costly wellbore failures and minimize the risk of environmental damage.

The response of CCL tools 140 is parameterized by the tool design, operating conditions and the characteristics of the physical casing structure. Therefore, the CCL tools can output different signatures across different collars. The CCL tools can identify different signatures, which depend on the type of casing and the manufacturing process used to create the collars. For example, some casing collars may have a distinctive shape or pattern that is easily recognizable, while others may be more subtle and difficult to identify.

To accurately locate casing collars and distinguish between different collar signatures, CCLs can use signal processing algorithms and advanced hardware. The tool emits electromagnetic signals that are reflected back by the casing collars and measures the time it takes for the signals to travel back and forth. By analyzing the amplitude and phase of the signals, as well as their travel time, the CCL can identify the presence of different collar signatures and provide accurate measurements of their location and depth within the wellbore.

In addition, measurements from the CCL tools 140 carry an uncertainty which needs to be accounted for as well. The uncertainty associated with CCL measurements is typically due to several factors, including the accuracy of the tool itself, variations in the casing collars being measured, and the conditions under which the measurements are taken. Tool positioning can impact uncertainty. For example, measurements taken in deviated or highly deviated wells may have a higher uncertainty due to the effects of tool positioning, borehole geometry, and other factors. The environmental conditions surrounding the wellbore can also affect the accuracy of CCL measurements. For example, variations in temperature, pressure, and humidity can affect the electrical properties of the formation and impact the strength of the signal reflected by the collar. The conditions inside the borehole can also affect the accuracy of CCL measurements. For example, variations in the borehole diameter or shape can affect the strength of the signal reflected by the collar and lead to measurement uncertainty. Additionally, variations in the borehole fluid can affect the electrical properties of the formation, which can also impact the accuracy of CCL measurements.

One or more ML models can be trained using time series data from CCL tools. The ML model can be trained to recognize an instance of casing collar signature and provide a detection uncertainty level. In one example, a collar detector block takes as input time series data from the CCL tool and detects collars. Based on the detection, the collar detector can give a detection depth, detection uncertainty, and the detection likelihood.

The time series data of the CCL tool can record the position and depth of casing collars along the length of the wellbore. As the CCL tool is lowered, it emits electromagnetic signals that are reflected back by the casing collars. The tool records the travel time of these signals, which is used to determine the depth and location of the casing collars. The time series data recorded by the CCL tool typically includes the depth of the casing collar, as well as the time and date of the measurement. The data can be recorded at regular intervals along the length of the wellbore, such as every foot or every few feet.

The outputs of the collar detector block can be used as inputs of a Bayesian sensor fusion model. A Bayesian sensor fusion model is a statistical model used to combine data from multiple sensors to improve the accuracy and reliability of a measurement. The model is based on Bayesian probability theory, which provides a way to update the probability of a hypothesis based on new evidence.

A Bayesian sensor fusion model can take the CCL instance and detection uncertainty as inputs, along with cable speed. The priors can also be inputs, such as reference CCL logs and casing tallies. The Bayesian sensor fusion model can then output an estimated depth and depth uncertainty, in an example.

Casing tallies are records that can provide information about the length, size, and/or type of casing that has been installed in a wellbore. The tallies can include a detailed list of the individual casing joints, along with their dimensions, grade, and connection type. Casing tallies are important for wellbore design and construction because they provide information about the depth and thickness of various formations, as well as the location of any obstructions or anomalies in the well. Casing tallies are typically created by field personnel as the casing is installed in the wellbore. The field personnel measure the length and diameter of each casing joint and record this information in a tally book or electronic database.

One advantage of the Bayesian sensor fusion model is that it can be updated in real-time as new sensor data becomes available. This allows the model to adapt to changes in the environment or sensor performance and provide accurate estimates of the physical quantity being measured.

Overall, a Bayesian sensor fusion model can be a powerful tool for improving the accuracy and reliability of wellbore position measurements by combining collar sensor data with other sensor data and accounting for the uncertainty associated with each measurement.

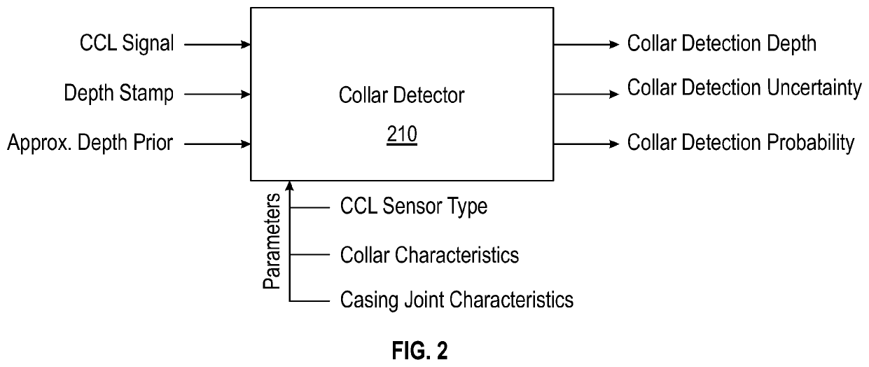

FIG. 2 is a schematic of an exemplary collar detector block 210 according to an aspect of the present disclosure. The collar detector block takes as input time-series data from the CCL tool and detects collars. The detection can include outputting a detection depth, detection uncertainty and the detection likelihood. The collar detector block can include a machine learning model that is used to produce the illustrated outputs based on the illustrated inputs.

A neural network is one type of machine learning model that can be used at the collar detector block. Neural networks consist of multiple interconnected layers of artificial neurons that can learn to recognize patterns in data and make predictions or decisions based on those patterns. A machine learning model, on the other hand, is a broader term that encompasses a wide range of statistical and computational algorithms that can be used to learn patterns and relationships in data. Machine learning models can include decision trees, logistic regression, support vector machines, random forests, and others.

The detection problem associated with operating on one-dimensional time series data can be treated either as a classification or a segmentation problem. In the first case, the time-series data can be broken into smaller windows, sliding across every sample to train a detector to determine if the contents of the window belong to a collar or not. In the latter case, a long interval of the time-series data can be used with a detector that classifies pointwise if it belongs to a collar or not. In order to generalize the solution, CCL signals can be stamped against depth to avoid distortions to the signatures. For example, the distortions can otherwise arise due to changes in operating conditions, specifically cable speed.

Both classical and machine learning based detectors can be used with the system. For example, the collar detector of FIG. 2 can use the inputs and prior parameters to create the collar detection outputs based on any of the following:
Bayesian statistical filter testing (Segmentation);
Matched Filtering (Segmentation);
Wavelet Decomposition with Shallow Neural Networks (Classification);
1D Convolutional Neural Networks (Classification);
Long Short-Term Memory (Classification); and
Long Short-Term Memory (Segmentation).

Bayesian filtering was described with regard to FIG. 1.

Matched filtering using segmentation is a signal processing technique that involves dividing a longer signal into shorter segments, and then applying a matched filter to each segment to identify specific features or patterns in the signal. A matched filter is a filter that is designed to maximize the signal-to-noise ratio (SNR) of a specific signal of interest. By convolving a signal with a matched filter, the SNR of the signal can be improved, making it easier to detect and identify.

Wavelet decomposition can be used with shallow neural networks as a preprocessing step to extract relevant features from time-series data. In this approach, the time-series data is decomposed into a set of wavelet coefficients at multiple scales using a wavelet transform. The resulting coefficients can then be used as inputs to a shallow neural network for further processing and classification.

1D Convolutional Neural Networks (CNNs) are a type of neural network architecture that can be used for processing and analyzing one-dimensional sequential data, such as the time-series data from the CCL.

Long Short-Term Memory (LSTM) is a type of recurrent neural network (RNN) architecture that is commonly used with time series data. LSTM networks are designed to learn and capture long-term dependencies and patterns in sequential data by using a memory cell and three gates: an input gate, an output gate, and a forget gate. These gates control the flow of information into and out of the memory cell, allowing the LSTM to selectively retain or discard information as needed.

When used with time series data, LSTM networks can be trained on a sequence of input data and their corresponding output data. The LSTM processes the input sequence one time step at a time, updating its internal state at each step based on the input and the previous state. The output of the LSTM at each time step can then be used to make predictions or classify the input data.

One of the key advantages of using LSTM networks with time series data is their ability to handle long-term dependencies and capture complex patterns in the data. Traditional feedforward neural networks and some other machine learning algorithms can struggle to capture these long-term dependencies, as they process each input independently without considering the context of previous inputs.

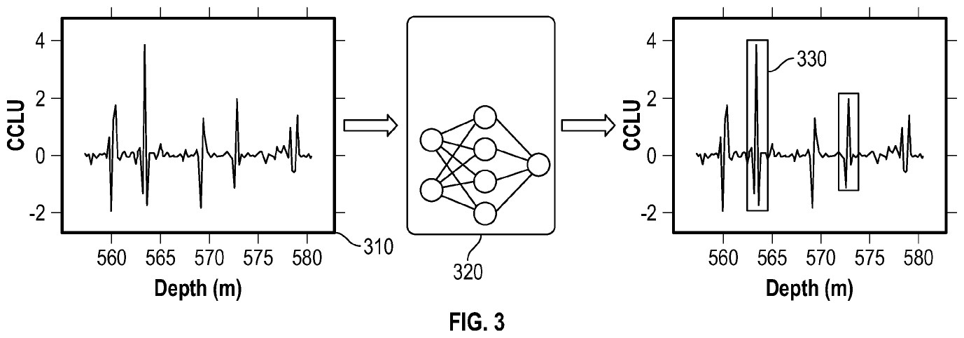

FIG. 3 is an illustration of an exemplary collar detector block according to an aspect of the present disclosure. Collar detection 330 can be accomplished using a trained ML model 320 with CCL sensor data 310 as in input, in an example.

Advanced machine learning techniques can be used to detect collar signatures by learning from past jobs. Neural networks can learn to identify unique patterns and signatures on time series data effectively. Whereas prior approaches that just look at sudden variances could lead to false detections, neural networks, such as one-dimensional convolutional networks and LSTMs, can be trained to learn typical collar signatures. The neural network can also be trained to estimate the probability that the signal contains collar components or that the signal does not contain collar components. These techniques have shown great performances in detecting collar signatures effectively. The advantage of this approach of detecting collars is that the detection likelihoods can be directly used to quantify detection uncertainty.

An understanding of the physics-based model of the CCL sensor enables the characterization of every collar signature based on the associated metadata. Example metadata includes Casing Joints characteristics, CCL Sensor Characteristics, Collar Characteristics, and Operating Conditions.

Here are some of the ways that these factors can impact the collar signature. The location and number of casing joints can affect the collar signature. Each casing joint can create a unique magnetic field that can be detected by the CCL sensor. The distance between casing joints can also impact the strength and shape of the collar signature. The sensitivity and resolution of the CCL sensor can impact the ability to detect collar signatures. Higher sensitivity sensors can detect smaller changes in magnetic field strength, which can improve the accuracy of collar detection. The size, shape, and material of the collar can all impact the collar signature. Collars with thicker walls or different shapes can create different magnetic fields that may be more or less detectable by the CCL sensor. The temperature, pressure, and other environmental factors can also impact the collar signature. Changes in temperature or pressure can affect the magnetic properties of the collar and the casing, which can alter the strength and shape of the collar signature.

To characterize collar signatures based on these factors, various techniques can be used, including statistical analysis and machine learning algorithms. These techniques can help identify patterns and relationships between different factors and collar signatures, which can improve the accuracy of collar detection and reduce uncertainty in measurements.

Combining the above two techniques ((1) ML of past jobs and (2) physics-based analysis of metadata) can enable accurate detections and precise uncertainty quantification in terms of depth.

The collar detection block can execute on a processor that is part of a computing device. The CCL sensor data 310 can be analyzed by software on the computing device. Computing devices typically contain a central processing unit (CPU) or other types of processing hardware, which is responsible for executing software programs and processing data. They also typically have some form of memory, such as random access memory (RAM), which allows them to store and retrieve data quickly. Some examples of computing devices include personal computers, laptops, servers, smartphones, tablets, gaming consoles, smart home devices, and many others. The capabilities and features of different computing devices can vary widely, depending on their intended use and the specific hardware and software they incorporate.

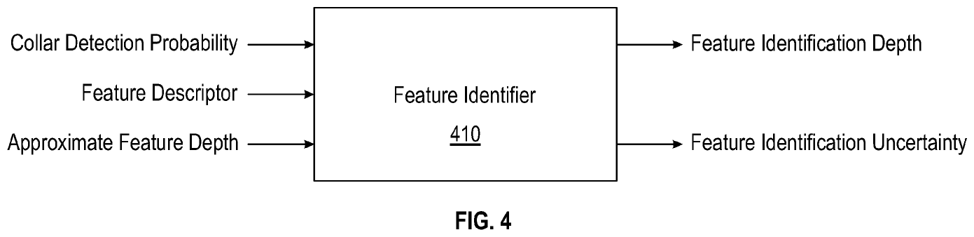

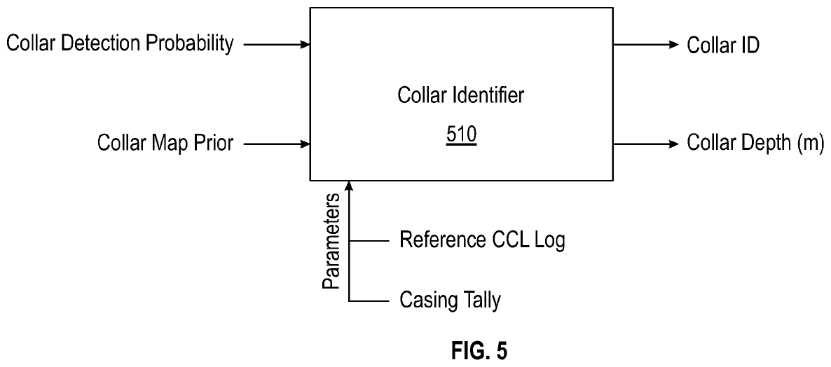

FIG. 4 is a schematic of an exemplary feature identifier model 410 according to an aspect of the present disclosure. The feature identifier 410 can also be a Collar Identifier of FIG. 5.

Given prior information from the users in the form of a casing tally or a reference log or a feature at known depth, collars detected using the collar detector can be mapped with the priors to perform depth correction and fusion in the later stages. Feature and Collar Identifier blocks can perform similar functions of mapping detections to priors. Feature identifier is specifically used for the “feature at-known depth” use case whereas the collar identifier is useful when the priors are from a casing tally or a reference log.

FIG. 5 is a schematic of an exemplary feature identifier model 410 according to an aspect of the present disclosure. Specifically, FIG. 5 illustrates a collar identifier 510. The collar identifier 510 can take as inputs the collar detection probability and a previously constructed pseudo casing tally called a collar map. The pseudo casing tally can be based on running the collar detector on the reference log before beginning the job.

Using detection likelihoods as opposed to explicit detection depths, the identifier block can be less dependent on the accuracy of the detectors. The identifier block can help characterize uncertainty as priors and likelihoods are probability distributions themselves.

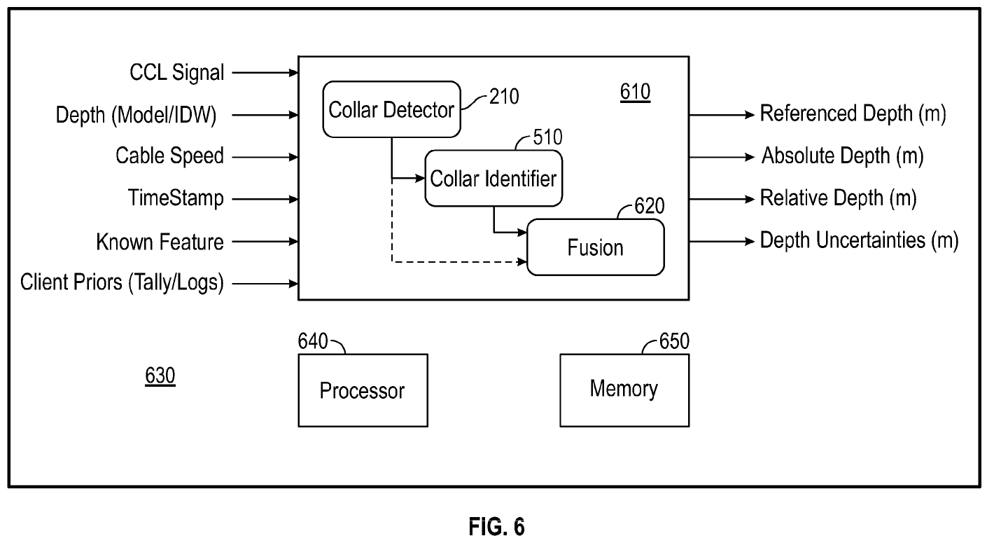

FIG. 6 is a schematic of an exemplary depth estimator framework 610 according to an aspect of the present disclosure. The framework 610 can execute on a computing device 630. The computing device 630 can be one or more processor-based devices, such as a laptop, personal computer, tablet, or server. The computing device can include at least one processor 640 that executes instructions on a memory 650, which can be a non-transitory, computer-readable medium.

One or more processor-based computing devices 630 can utilize CLL signal measurements and prior information to make depth measurements and determine depth uncertainty. A collar detector 210 can be a process that includes a machine learning model in one example. The collar detector 210 can execute on a processor 640 and receive a casing collar locator (“CCL”) signal, a depth stamp, and a prior parameter (also called “priors”). These priors can include casing tallies, reference CCL logs, and known features of the wellbore or collar. When a collar is detected, the collar detector can output a detection depth and a collar detection probability.

These outputs can be received at a collar identifier 510, which can be an additional process that provides correlation functionality. The collar identifier 510 can execute on the same or different processor(s) 640 as the collar detector 210. In addition to the outputs of the collar detector 210, prior parameters can also be inputs to the collar identifier. The collar identifier 510 can output a collar depth and a collar ID (identifying the detected collar).

A fusion process 620 can correlate prior information when the detection probability meets a threshold. The framework 610 can then output a depth and depth certainty for the collar. The fusion process 620 is also referred to as the depth estimator block 620.

The depth estimator block 620 fuses the outputs of raw signal inputs, detections and identifications to continually estimate absolute depth (physical along-hole depth). To this end, a simple Bayesian Kalman Filter can be used to fuse the sensor data coupled with measurements in the form of detections and identifications. An advantage of the Bayes approach is that they are based on probability theories. A Bayes filter not only outputs the inferred parameters, but also quantifies the uncertainty based on the measurement noises and the so-called process noise that characterizes the stochastic nature of the forward models. In its core, the filter calculates the joint probability distribution between the parameter and the measured variables. It then uses the received measurement to update the conditional probability distribution of the parameters (i.e., what is updated probability distribution of the parameters, conditioned on the received measurements?). Another advantage of the Bayes filters is that it is easy to incorporate prior knowledges to the inference framework. In this proposed framework, measurement updates are performed asynchronously to the process updates only when a collar that is expected is detected and identified.

The internal functionalities of the fusion framework 610 depend on the use case. For example, when the user provides a reference CCL log from a previous job, a pseudo casing tally can be generated pre-job by running the collar detector on the reference log. In this case, during runtime, collar detection and identification can simplify to correlation given the right portions of the signal. Incorporating prior information and correlating only when a collar is expected, improves runtime efficiency, and more importantly eliminates false detections. In one example, therefore, the collar identifier and fusion blocks only receive inputs and execute when the collar detector has detected a collar with a threshold level of certainty.

In the presence of a casing tally, a collar map can be built directly based on the tally containing casing joint lengths. Incorporating a Bayesian sensor fusion approach, collar detectors can be used during run-time to detect collars in regions identified based on the priors. Detected collars are then identified to perform measurement updates and hence perform depth corrections to adjust detected depths to client provided reference depths.

The case of identifying a known feature at an approximate depth is a simplified version of the casing tally use case, wherein only one feature (e.g., successive casing joint lengths) is provided as prior as opposed lengths of all casing joints. In this scenario, the collar detector and identifier are employed exactly once to identify the feature and perform necessary corrections.

The inputs to the framework can include the CCL Signal, the collar depth metadata such as the collar model and the inside diameter of the wellbore (“IDW”), cable speed of the wireline, a timestamp, known feature information, and client priors. The outputs can be referenced depth, absolute depth, relative depth, and depth uncertainty. These can be different ways of measuring the depth of the collar.

Referenced depth refers to the depth of the collar or another well component relative to a specific reference point or datum. The reference point could be the top of the wellbore, the sea level, or a known depth point in the well. Referenced depth is often used to measure the total depth of the well, and it's a common reference point for other depth measurements.

Absolute depth refers to the depth of a collar or other well component measured from the surface of the ground or water to the component itself. Absolute depth is a direct measurement of the actual depth of the component in the well, regardless of any reference point.

Relative depth refers to the depth of a collar or well component relative to other components in the well. For example, a casing collar locator might be used to measure the depth of a particular casing string relative to the previous casing string in the well. Relative depth measurements are often used to identify the location of specific well components and to ensure that they are properly spaced and positioned.

Overall, these three depth measurements can serve different purposes in well logging and downhole operations. Referenced depth is a common reference point for depth measurements, absolute depth provides a direct measurement of the component's depth, and relative depth is useful for comparing the depth of different well components.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for tool string depth estimation, comprising:
receiving, at a collar detector that executes on a processor, a casing collar locator (“CCL”) signal, a depth stamp, and a prior parameter;
outputting, from the collar detector, a collar detection depth and a collar detection probability;
receiving, at a collar identifier, at least one of the outputs of the collar detector and a prior a parameter;
outputting, from the collar identifier, a collar depth and a collar identifier;
correlating prior information when the detection probability meets a threshold; and
outputting a depth and depth certainty for the collar identifier.

2. The method of claim 1, wherein the collar identifier receives a prior casing tally as an input.

3. The method of claim 1, further comprising receiving the outputs of the collar detector at a feature identifier, wherein the feature identifier outputs a feature depth and a feature uncertainty, both of which are correlated to prior information to output the depth and depth uncertainty.

4. The method of claim 1, wherein the collar detector organizes time series data of the CCL signal into segments that are used as inputs to a machine learning model, wherein the collar detection probability corresponds to respective segments.

5. The method of claim 1, wherein the collar detector further outputs a collar detection uncertainty that is used in determining the depth certainty.

6. The method of claim 1, wherein samples of the CCL signal are stamped against depth and the depth stamps are used to match and identify collars.

7. The method of claim 1, wherein the collar detector uses the inputs and prior parameters to create the collar detection outputs based on segmentations of the CCL signal, and wherein the collar detector executes a function to perform at least one of:
Bayesian statistical filter testing;
Matched Filtering; and
Long Short-Term Memory.

8. The method of claim 1, wherein the collar detector uses the inputs and prior parameters to create the collar detection outputs based on classification of the CCL signal, and wherein the collar detector includes at least one of:
Wavelet Decomposition and Shallow Neural Networks;
One-dimensional Convolutional Neural Networks; and
Long Short-Term Memory.

9. The method of claim 1, wherein the depth and depth certainty outputs are used to automate depth control in real-time of a wireline conveyance.

10. A non-transitory, computer-readable medium containing instructions for a casing collar locator (“CCL”) framework for detection and depth control, the instructions when executed by a processor causing the processor to perform stages comprising:
receiving as inputs at least three of a CCL signal, a CCL depth, a cable speed, a timestamp, a known feature, and prior information, wherein the prior information includes at least one of a casing tally, a reference log, and a known feature at an approximate depth;
sending the CCL signal to a trained machine learning model, the machine learning model identifying a collar depth and an identification probability; and
when the identification probability is above a threshold, outputting a depth and a depth uncertainty.

11. The non-transitory, computer-readable medium of claim 10, the stages further comprising receiving the outputs of the collar detector at a feature identifier, wherein the feature identifier outputs a feature depth and a feature uncertainty, both of which are correlated to prior information to output the depth and depth uncertainty.

12. The non-transitory, computer-readable medium of claim 10, wherein the collar detector further outputs a collar detection uncertainty that is used in determining the depth certainty, and wherein samples of the CCL signal are stamped against depth and the depth stamps are used to match and identify collars.

13. The non-transitory, computer-readable medium of claim 10, wherein the depth and depth certainty outputs are used to automate depth control in real-time of a wireline conveyance.

14. The non-transitory, computer-readable medium of claim 10, wherein the collar detector uses the inputs and prior parameters to create the collar detection outputs based on segmentations of the CCL signal, and wherein the collar detector executes a function to perform at least one of:
Bayesian statistical filter testing;
Matched Filtering; and
Long Short-Term Memory.

15. The non-transitory, computer-readable medium of claim 10, wherein the collar detector uses the inputs and prior parameters to create the collar detection outputs based on classification of the CCL signal, and wherein the collar detector includes at least one of:
Wavelet Decomposition and Shallow Neural Networks;
One-dimensional Convolutional Neural Networks; and
Long Short-Term Memory.

16. A wireline system, the wireline system comprising:
a winch;
a tool string;
a casing collar locator (“CCL”) connected to the tool string; and
a depth estimator framework that executes on a processor to perform stages comprising:
receiving, at a collar detector that executes on a processor, a signal from the CCL, a depth stamp, and a prior parameter;
outputting, from the collar detector, a collar detection depth and a detection probability;
receiving, at a collar identifier, at least one of the outputs of the collar detector and a prior a parameter;
outputting, from the collar identifier, a collar depth and a collar identifier;
correlating prior information when the detection probability meets a threshold; and
outputting a depth and depth certainty for the collar identifier, wherein the depth and depth certainty are used to automate an operation of the wireline system.

17. The system of claim 15, the stages further comprising receiving the outputs of the collar detector at a feature identifier, wherein the feature identifier outputs a feature depth and a feature uncertainty, both of which are correlated to prior information to output the depth and depth uncertainty.

18. The system of claim 15, wherein the collar detector organizes time series data of the CCL signal into segments that are used as inputs to the machine learning model, wherein the collar detection probability corresponds to respective segments.

19. The system of claim 15, wherein the collar detector further outputs a collar detection uncertainty that is used in determining the depth certainty, and wherein samples of the CCL signal are stamped against depth and the depth stamps are used to match and identify collars.

20. The system of claim 15, wherein the depth and depth certainty outputs are used to automate depth control in real-time of a wireline conveyance.
